(19) United States
(12) Patent Application Publication
(10) Pub. No.: US 2025/0142504 A1
(43) Pub. Date: May 1, 2025

(54) TIMING ADVANCE VALIDATION ENHANCEMENTS IN CONFIGURED GRANT SMALL DATA TRANSMISSIONS

(71) Applicant: APPLE INC., Cupertino, CA (US)

(72) Inventors: Jie Cui, San Jose, CA (US); Manasa Raghavan, Sunnyvale, CA (US); Dawei Zhang, Saratoga, CA (US); Yang Tang, San Jose, CA (US); Chunhai Yao, Beijing (CN); Qiming Li, Beijing (CN); Xiang Chen, Campbell, CA (US); Hong He, San Jose, CA (US); Yushu Zhang, Beijing (CN); Fangli Xu, Beijing (CN)

(21) Appl. No.: 18/837,318

(22) PCT Filed: Feb. 11, 2022
(86) PCT No.: PCT/CN2022/076067

§ 371 Date: Aug. 9, 2024

(51) Int. Cl. H04W 56/00; H04B 17/318; H04W 76/28

(52) U.S. Cl. CPC H04W 56/0045; H04B 17/328; H04W 76/28

(57) ABSTRACT

Systems and methods for performing timing advance (TA) validation at a user equipment (UE) for a TA to be used when transmitting a configured grant small data transmission (CG-SDT). Mechanisms for bounding one or more measurement windows during which one or more synchronization signal blocks are measured during a reference signal received power (RSRP) measurement method of the TA validation are discussed, and may be set using information corresponding to timing drift due to relativistic effects, clock differences between a UE and a base station, and/or information about a UE discontinuous reception (DRX) cycle. Further, time interval limitations between various events attendant to such an RSRP measurement method are discussed as being determined using information corresponding to timing drift due to relativistic effects, clock differences between a UE and a base station, information about a DRX cycle used at the UE, and/or a maximum TA timer duration.

### TECHNICAL FIELD

This application relates generally to wireless communication systems, including wireless communications systems implementing timing advance (TA) adjustments to configured grant small data transmissions (CG-SDTs).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 910 MHz to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a table describing a pair of methods used for TA validation, according to embodiments herein.

FIG. 2 illustrates the use of an RSRP measurement method during TA validation, according to embodiments herein.

FIG. 3 illustrates a method for bounding a measurement window of a TA validation for a CG-SDT, in accordance with one embodiment.

FIG. 4 illustrates a method for bounding a measurement window of a TA validation for a CG-SDT, in accordance with one embodiment.

FIG. 5 illustrates a method for TA validation for a CG-SDT, in accordance with one embodiment.

FIG. 6 illustrates a method for bounding a time T2 at which the UE determines whether to perform a CG-SDT within a TA validation, in accordance with one embodiment.

FIG. 7 illustrates a method for bounding a time T2 at which the UE determines whether to perform a CG-SDT within a TA validation, in accordance with one embodiment.

FIG. 8 illustrates an example architecture of a wireless communication system, according to embodiments disclosed herein.

FIG. 9 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

A RAN (such as an NG-RAN) and/or a connected UE may implement and/or use a state machine relative to radio resource control (RRC) aspects of the UE in order to manage an RRC state of the UE in an organized, coherent fashion. Accordingly, in NR, a UE may be in one of an RRC_CONNECTED (CONNECTED) state, an RRC_IDLE (IDLE) state, and an RRC_INACTIVE (INACTIVE) state.

The CONNECTED state, the UE has an active connection to the CN and an established RRC context with the RAN. General data transfer may occur in this state.

In the IDLE state, the UE has neither an active connection to the CN nor an established RRC context with the RAN. In this state, it may be that no data transfer occurs.

In an INACTIVE state, control plane (CP) aspects for the UE include a non-access stratum (NAS) connection to the CN. However, as to an RRC connection of the UE in the INACTIVE state, the UE has no dedicated access stratum (AS) resource (though the UE may, upon entering the INACTIVE state, save an RRC configuration from prior to entering the INACTIVE state).

In the INACTIVE state, user plane (UP) aspects include that the UE does not regularly perform dedicated data transmission and/or reception. To perform such dedicated data transmissions and/or receptions, it may be that the UE first enters a CONNECTED state instead. For example, for a downlink (DL) transmission, a base station of the RAN pages the UE via a RAN-paging mechanism in order to trigger the UE to enter the CONNECTED mode. For an uplink (UL) transmission, the UE triggers a random access channel (RACH) procedure in order to enter the CONNECTED mode.

A state transition at the UE from a CONNECTED state to an INACTIVE state may be triggered by the reception at the UE from the network of an RRCRelease message. A state transition at the UE from an INACTIVE state to a CONNECTED state may be triggered by the reception at the UE from the network of an RRCResume message. A state transition at the UE from an INACTIVE state to an IDLE state may be triggered by an RRCRelease message from the network. Alternatively, the UE may drop to an IDLE state from another state when it cannot locate a serving cell.

It has been recognized that many modern applications for UEs may implement the transmission of small amounts of data in the UP to the network. Further, these small data UP transmissions may be infrequent, relatively speaking. For example, a UE may need to report a single sensor reading, a small amount of text, etc., and/or to report such data at infrequent intervals. It has been recognized that in some of these cases, the transition of the UE to and/or from a CONNECTED mode in order to perform these small data transmissions (and then perhaps return to an INACTIVE mode) (as described above) involves the use of relatively large amounts of network resources (in the form of signaling between the network and the UE, computation at each of the network and the UE, and time) as compared to the small amount of data that is to be transmitted.

A small data transmission (SDT) procedure may be used at a UE that is in an INACTIVE mode that does not require a transition of the UE from the INACTIVE to a CONNECTED state in order to perform such transmissions of small amounts of UP data. Such an SDT procedure may provide a mechanism for the transmission of UP data in an uplink (UL) direction while the UE remains in an INACTIVE state. Because a state change from INACTIVE to CONNECTED is not required, the SDT procedure may use relatively fewer network resources than existing methods to complete such transmission(s). Finally, the SDT procedure may be random access channel (RACH) procedure based, or it may use pre-configured physical uplink shared channel (PUSCH) resources.

An SDT procedure that is based on a configured grant for the SDT may be referred to as a configured grant small data transmission (CG-SDT). Using CG-SDT methods, a UE may be configured such that it is aware of periodic CG-SDT occasions that may (but are not required to) be used for an SDT, in the manner described above.

A TA adjustment may be used by the UE to modify (e.g., move earlier) the time of a UL transmission (relative to, e.g., the DL transmissions from the base station). This may be done in order to align the time of receipt of the UL transmission at the base station with the receipt of other UL transmissions from other UEs in communication with the base station (with each UE potentially using a (potentially) different TA adjustment based on, e.g., its distance from the base station), and/or with the timing used by the base station more generally. The UE may accordingly use such a TA adjustment with any CG-SDT transmission that it wishes to perform during a CG-SDT occasion, much as it might with some other transmission that is performed when the UE is in a CONNECTED mode.

However, it has been recognized that when in the INACTIVE mode, it is possible for a TA adjustment amount that is configured to the UE to become stale. Note that because the UE is not actively communicating with a base station of the RAN when in INACTIVE mode, the constant verification/upkeep of an appropriate TA adjustment amount to be used by the UE is not had between the UE and the base station. Accordingly, when the UE is in an INACTIVE mode, the TA adjustment amount used by the UE may not be updated correspondingly to, for example, UE position changes within the cell in order to reflect a corresponding change in the signal traversal time between the UE and the base station due to such a position change. As will be discussed below, other reasons for which the TA adjustment amount can become stale are also possible.

It may be that UL CG-SDT transmissions (which occur in the INACTIVE mode) that are sent according to a stale TA adjustment timing of the UE may be misaligned at the base station receive side (relative to the timing used by the base station/other UEs). This can cause communication issues between the UE and the base station. Further, any such misaligned signaling activity may act as interference within the cell between the other UEs and the base station.

The point at which misalignment begins to be an issue from the base station perspective may be when a transmission from the UE is outside a known timing error tolerance (denoted Tₑ) for the UE within the wireless communication system, where the Tₑ may correspond to an amount misalignment slack that is tolerable within the wireless communication system (e.g., which may be based on a cyclic prefix length used with transmissions between the UE and the base station, etc.). Further details regarding Tₑ may be found in 3GPP TS 38.211, version 17.0.0 (December 2021), “NR; Physical Channels and Modulation,” section 7.1.2-1.

In order to prevent such problematic transmissions, a UE that is to perform a CG-SDT transmission may first perform a TA validation process in order to determine whether or not is present TA adjustment amount has become stale, and may cancel any CG-SDT transmission if it determines that this is the case.

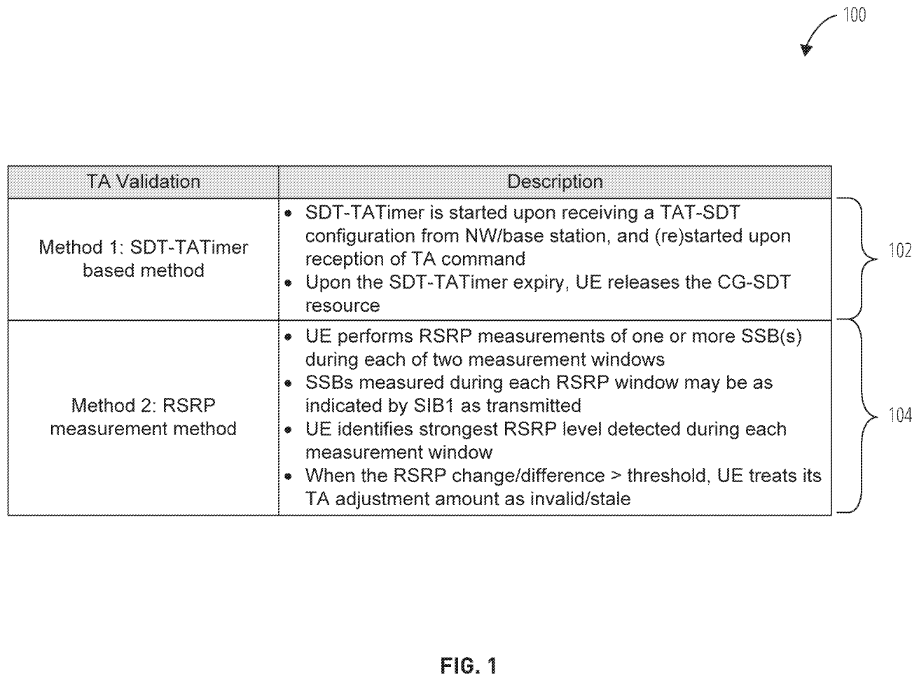

FIG. 1 illustrates a table 100 describing a pair of methods used for TA validation, according to embodiments herein. The table 100 includes descriptions for a small data transmission timing advance timer (SDT-TATimer) based method 102 used for TA validation and a reference signal received power (RSRP) measurement method 104 used for TA validation.

The SDT-TATimer based method 102 is now discussed. The UE may receive a timing advance timer small data transmission (TAT-SDT) configuration from the network (e.g., via the base station). This TAT-SDT configuration may provide the UE with a TA adjustment amount that is to be used for any CG-SDT transmissions. Upon receipt of the TAT-SDT configuration, the UE may start an SDT-TATimer that is configured to denote a maximum amount of time that this TA adjustment amount is to be considered valid (not stale) by the UE. The starting value (or maximum duration) of the SDT-TATimer may also be provided in the TAT-SDT configuration.

When the SDT-TATimer expires, the UE releases the associated CG-SDT resource, and accordingly may not perform any CG-SDT transmissions until another CG-SDT resource is configured to the UE, and an additional TAT-SDT configuration is provided to the UE.

It may be that the SDT-TATimer based method 102 is constantly used by the UE. In other words, it may be that the SDT-TATimer based method 102 is used alongside/with any other method (e.g., such as the RSRP measurement method 104) in order to perform TA validation.

The RSRP measurement method 104 is now discussed. The UE performs RSRP measurements of one or more synchronization signal blocks (SSB(s)) during each of two measurement windows. The SSBs measured during each RSRP window may be SSBs that are indicated as being transmitted by the base station in SIB1. Each SSB may be understood to be transmitted on a corresponding base station transmit (Tx) beam.

For each of the two measurement windows, the UE identifies strongest RSRP level detected. When the difference between these two RSRP measurements is greater than a threshold, the UE treats its TA adjustment amount as invalid/stale. This may be because the change in RSRP measurement represents that the UE is/has been translated within the cell relative to the base station, such that the propagation distance of a signal from the UE to the base station has changed (thereby affecting maximum RSRP levels between the two measurement windows). Accordingly, the UE may determine (based on the magnitude of the RSRP change) that TA adjustment amount used by the UE may not appropriately correspond to the UE's new position (e.g., it is stale), and that a CG-SDT transmission should not be performed until updated an updated (e.g., not stale) TA adjustment amount can be determined.

The determined two strongest RSRP values (one from each window) may correspond to the same SSB, or to different SSBs. The use of a strongest RSRP corresponding to a first SSB during the first window and a strongest RSRP corresponding to a second (different) SSBs during the second window may correspond to the case where the UE has not been translated within the cell relative to the base station, but where the UE has been rotated. In such a case, it may not be expected that the propagation distance of a signal from the UE to the base station has changed (and therefore the TA adjustment amount is not stale), but that a different SSB (on a different corresponding beam) will be the best as between the two measurement windows.

It is contemplated that the RSRP measurement method 104 may be used with the SDT-TATimer based method 102 as part of a TA validation process. In other words, the UE may perform both of the SDT-TATimer based method 102 and the RSRP measurement method 104 simultaneously/jointly, and if either of the SDT-TATimer based method 102 and/or the RSRP measurement method 104 determines that conditions are such that a CG-SDT transmission should not be performed, any CG-SDT transmissions may be cancelled until such a time as transmission conditions for both the SDT-TATimer based method 102 and the RSRP measurement method 104 (assuming that both are being used by the UE) can be met.

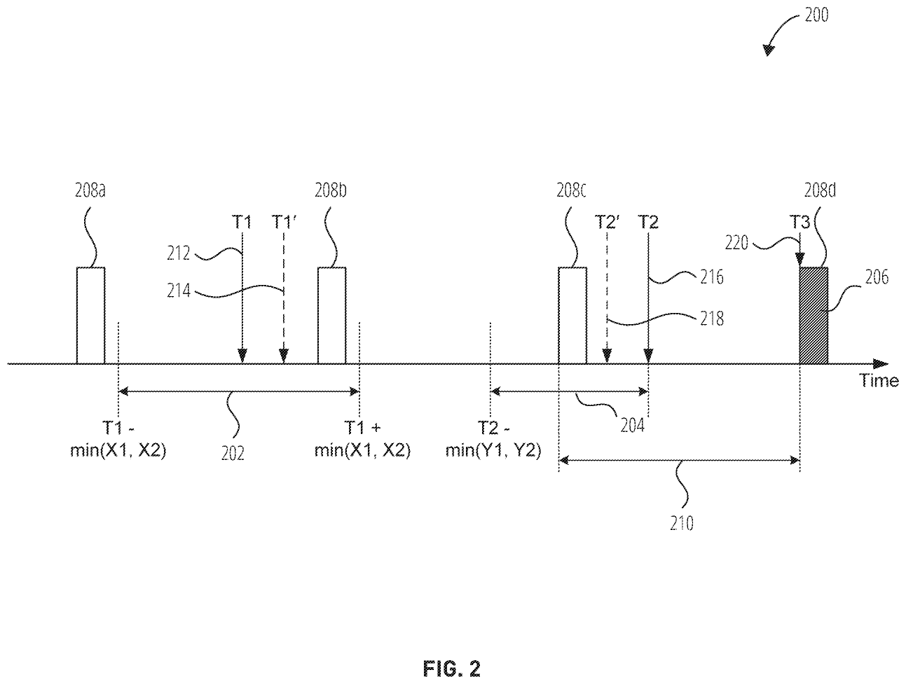

FIG. 2 illustrates the use of an RSRP measurement method 200 during TA validation, according to embodiments herein The RSRP measurement method 200 uses RSRP measurements during a first measurement window 202 and a second measurement window 204 to determine whether to perform a CG-SDT transmission 206, in the manner described above.

The embodiment illustrated in FIG. 2 anticipates that the UE is configured with CG-SDT transmission occasions 208 according to a CG-SDT periodicity 210. In FIG. 2, a first CG-SDT transmission occasion 208a, a second CG-SDT transmission occasion 208b, a third CG-SDT transmission occasion 208c, a fourth CG-SDT transmission occasion 208d are illustrated. As shown in FIG. 2, the fourth CG-SDT transmission occasion 208d is configured to be used by the UE to send a CG-SDT transmission 206, assuming that any difference between the highest RSRP value measured on an SSB during the first measurement window 202 and the highest RSRP value measured on an SSB during the second measurement window 204 are within a threshold amount, in the manner discussed above.

The arrangement (in time) of the first measurement window 202 will now be discussed. The first measurement window 202 may be arranged relative to the time T1 212, which is a time at which at which latest TA timer reset information for a TA timer is received at the UE from a base station. This TA timer reset information may be for an SDT-TATimer, as described above. This TA timer reset information may include a TA command TA value that is used by the UE to calculate an intermediate N_{TA} value that is then itself used to calculate the actual TA adjustment amount T_{TA}. This TA timer reset information may be received in a in a random access response (RAR) on a physical downlink control channel (PDCCH) (e.g., in the case of the initial setup of a SDT-TATimer configuration using a UE random access procedure), or may be received in a TA command medium access control control element (MAC CE) (e.g., in the case of an update to an existing SDT-TATimer configuration).

The first measurement window 202 may be accordingly arranged around the time T1 212 such that it begins at a time T1−min(X1, X2) and ends at a time T1+min(X1, X2), as illustrated by FIG. 2. Various manners of determining bounds for the value of min(X1, X2) are discussed below.

As further illustrated in FIG. 2, the first measurement window 202 includes an indication of a time T1′ 214, which is a time at which the UE has completed the RSRP measurement of the one or more SSBs corresponding to the first measurement window 202, in the manner described above. It is noted that the illustrated location of time T1′ 214 within the first measurement window 202 is given by example, and that that the time T1′ 214 could in other embodiments occur at any other time within the first measurement window 202.

The arrangement (in time) of the second measurement window 204 will now be discussed. The second measurement window 204 may be arranged relative to the time T2 216, which is a time at which the UE make an ultimate TA validation determination for the CG-SDT transmission 206 (e.g., that controls whether or not the CG-SDT transmission 206 will actually be sent during the fourth CG-SDT transmission occasion 208d). The second measurement window 204 is accordingly arranged relative to the time T2 216 such that it begins at a time T2−min(Y1, Y2) and ends at the time T2 216. Various manners of determining bounds for the value of min(Y1, Y2) are discussed below.

As further illustrated in FIG. 2, the second measurement window 204 includes an indication of a time T2′ 218, which is a time at which the UE has completed the RSRP measurement of the one or more SSBs corresponding to the second measurement window 204, in the manner described above. It is noted that the illustrated location of the time T2′ 218 within the second measurement window 204 is given by way of example, and that the time T2′ 218 could in other embodiments occurs at any other time within the second measurement window 204.

During an RSRP measurement method 200, in the case that either the SSB measurement(s) corresponding to the first measurement window 202 are actually completed outside the first measurement window 202 and/or the SSB measurement(s) corresponding to the second measurement window 204 are actually completed outside the second measurement window 204, the UE will understand that there is problematic misalignment between the UE and the base station due to some form of timing drift between the UE and the base station. The UE may accordingly assume that its TA adjustment amount is accordingly not appropriate to cause the CG-SDT transmission 206 to arrive at the base station with a proper alignment (from the base station/system perspective). The UE may accordingly in response cancel the CG-SDT transmission 206.

Accordingly, bounds on allowable values for min(X1, X2) and min(Y1, Y2) may be set such that the existence of time T1′ 214 and time T2′ 218 within those respective measurement windows ensures that that one or more possible sources of such timing drift have not reached a level of magnitude that causes concern that any overall timing misalignment due to timing drift between the UE and base station has reached an unacceptable level (such that there is concern that the TA adjustment amount to be used for the CG-SDT transmission 206 may have been accordingly made stale).

It is noted that the actual value of min(X1, X2) and/or min(Y1, Y2) may be set by the UE within the bounds for min(X1, X2) and/or min(Y1, Y2) as described herein. In other words, the bounds discussed herein are not (necessarily) the same as the actual values for min(X1, X2) and/or min(Y1, Y2) that may be ultimately used.

Herein, discussion may relate to the setting of bounds for allowable location for measurement windows (where such windows may be defined by min(X1, X2) and min(Y1, Y2)) in order to check for such timing drifts relative to a Tₑ value used within the wireless communication system for transmissions between the UE and the base station. These bounds for the measurement windows may be set such that the UE analysis of whether the time T1′ 214 and the time T2′ 218 properly falls inside its respective measurement window also acts to inform the UE whether there is a concern that a Tₑ constraint between the UE and the base station has been violated due to timing drift (and, if so, the UE can then cancel the CG-SDT transmission 206).

Timing drift between the UE and the base station can occur due to relativistic effects caused by a velocity of the UE relative to the base station. A formula that that relates a maximum allowable window variation S to the Tₑ constraint used between the UE and the base station as affected by timing drifts due to relativistic effects may be written as

$$\frac{S * {υ}_{UE}}{c} \leq k * {T}_{e}$$

which can be rewritten as

$$S \leq \frac{k * {T}_{e} * {υ}_{U E}}{c}$$

where k is a scaling factor, c is the speed of light, and v_{UE} is the velocity of the UE relative to the base station.

Accordingly, the value of

$$\frac{k * {T}_{e} * {υ}_{U E}}{c}$$

may be used as an outer bound adjustment amount that is used to set a upper and/or lower outer bound for the first measurement window 202 relative to the time T1 212, and/or may be used to set a lower outer bound for the second measurement window 204 relative to the time T2 216. For example, the lower outer bound for the first measurement window 202 may be found at

$$T 1 - \frac{k * {T}_{e} * {υ}_{U E}}{c} ,$$

(corresponding to a negative direction from the time T1 212 while an upper outer bound for the first measurement window 202 may be found at

$$T 1 + \frac{k * {T}_{e} * {υ}_{U E}}{c}$$

(corresponding to a positive direction from the time T1 212). Further, the lower outer bound for the second measurement window 204 may be found at

$$T 2 - \frac{k * {T}_{e} * {υ}_{U E}}{c}$$

(corresponding to a negative direction from the time T2 216), with the relevant upper bound occurring directly at the time T2 216.

By then ensuring at the UE that its actual measurement windows (as defined by the value of min(X1, X2) and min(Y1, Y2)) as illustrated in FIG. 2 are within these bounds, the UE can be assured that the analyses of whether the time T1′ 214 properly occurs during the first measurement window 202 and whether the time T2′ 218 properly occurs during the second measurement window 204 act to check for unacceptable magnitudes of relativistic effects (because the first measurement window 202 and the second measurement window 204 have themselves been bounded in a manner that takes into account to these relativistic effects).

As an example, suppose a case where a subcarrier spacing (SCS) is 15 kilohertz (kHz) in both UL and DL. The relevant Tₑ constraint (e.g., as defined by a definition/specification for the wireless communication system) may be understood to be determined as Tₑ=12*64Tₑ, where Tₑ is equal to the basic time unit (which in NR is around 0.509 nanoseconds (ns)). Take the UE speed to be 120 kilometers per hour (km/h) and the scaling factor k as 0.25. Then, the evaluation of

$$\frac{k * {T}_{e} * {υ}_{U E}}{c}$$

results in 880 milliseconds (ms). In such a case, the first measurement window 202 may have a lower outer bound at a time T1−880 ms and an upper outer bound at a time T1+880 ms. Further, the second measurement window 204 may have a lower outer bound at a time T2−880 ms (with an upper bound at T2). The actual values of min(X1, X2) and min(Y1, Y2) used by the system to determine the actual window placement within, respectively, the first measurement window 202 and the second measurement window 204 would accordingly be selected to fall within these bounds.

Potential values for the scaling factor k may include 1, 0.5, 0.25, 2, etc., depending on the desired level of tolerance within the wireless communication system relative to the T_{c} constraint. In some cases, the scaling factor k may be selected based on a total number of windows during which SSB measurement(s) will be taken. For example, if SSB measurements are to be taken during two measurement windows (as illustrated in FIG. 2), a scaling factor of k=0.5 may be used (such that the value

$$\frac{k * {T}_{e} * {υ}_{U E}}{c}$$

used for one of the two windows heuristically reflects half of the total allowable window variation across the two measurement windows for its (one) associated window). In whatever case, the value of k could be indicated to the UE by the network, or may be pre-configured to the UE according to a formal definition/specification for the wireless communication system.

In some embodiments, the discontinuous reception (DRX) cycle length may (also) be used by the UE to determine an outer bound for one or both of the first measurement window 202 and the second measurement window 204. For example, a UE may be understood to perform any SSB measurements for the first measurement window 202 and the second measurement window 204 during on time(s) of the DRX cycle used by the UE. In such a case, any measurement of an SSB that is taken further than the closest DRX on time for measuring that SSB on a given UE Rx beam to the time T1 212 (in the case of the first measurement window 202) or the time T2 216 (in the case of the second measurement window 204) should be understood to be not relevant.

Accordingly, the UE may bound the values of min(X1, X2) and min(Y1, Y2) by this amount of time, which may be expressed as

M*DRX
where DRX is the DRX cycle time, and M corresponds to a number of DRX cycles necessary for the UE to perform SSB measurements on all of its receive (Rx) beams (where, e.g., M=1 in the event that the UE does not use multiple Rx beams).

Thus, in some embodiments, it will be understood that the values of min(X1, X2) and min(Y1, Y2) may be bounded by either

$$\frac{k * {T}_{e} * {υ}_{U E}}{c}$$

or M*DRX, whichever is smaller. The UE may accordingly calculate both values when determining outer bounds for the first measurement window 202 and the second measurement window 204. In the event that the M*DRX value is the smaller value, the lower outer bound for the first measurement window 202 may be found at T1−M*DRX (corresponding to a negative direction from the time T1 212), while an upper outer bound for the first measurement window 202 may be found at T1+M*DRX (corresponding to a positive direction from the time T1 212). Further, the lower outer bound for the second measurement window 204 may be found at T2−M*DRX (corresponding to a negative direction from the time T2 216), with the relevant upper bound occurring directly at the time T2 216.

Timing drift between the UE and the base station can occur due to clock hardware differences between the UE and the base station. For example, the crystal in a clock of the UE may not be an exact match or exactly the same as a crystal in a clock used at the base station. Further, operational temperature differences between the base station and the UE may impose different thermal environments on their respective crystals, thereby causing a difference in clock behavior at each of the base station and the UE. It is contemplated that these timing drifts due to clock differences may be in addition to any timing drifts due to relativistic effects as described herein. Accordingly, a formula that that relates a maximum allowable window variation S to the Tₑ constraint used between the UE and the base station as affected by timing drifts due to both relativistic effects and clock differences may be written as

$$\frac{S * {υ}_{U E}}{c} + S * {R}_{UE} \leq k * {T}_{e}$$

which can be rewritten as

$$S \leq \frac{k ⋆ {T}_{e}}{\frac{{v}_{U E}}{c} + {R}_{U E}}$$

where k is a scaling factor, c is the speed of light, v_{UE} is the velocity of the UE relative to the base station, and R_{UE} is a clock drift rate of the UE relative to the base station given in parts per million (ppm).

Accordingly, the value of

$$\frac{k ⋆ {T}_{e}}{\frac{{v}_{U E}}{c} + {R}_{U E}}$$

may be used as an outer bound adjustment amount that is used to set a upper and/or lower outer bound for the first measurement window 202 relative to the time T1 212, and/or may be used to set a lower outer bound for the second measurement window 204 relative to the time T2 216. For example, the lower outer bound for the first measurement window 202 may be found at

$$T 1 - \frac{k ⋆ {T}_{e}}{\frac{{v}_{U E}}{c} + {R}_{U E}}$$

(corresponding to a negative direction from the time T1 212 while an upper outer bound for the first measurement window 202 may be found at

$$T 1 - \frac{k ⋆ {T}_{e}}{\frac{{v}_{U E}}{c} + {R}_{U E}}$$

(corresponding to a positive direction from the time T1 212). Further, the lower outer bound for the second measurement window 204 may be found at

$$T 2 - \frac{k ⋆ {T}_{e}}{\frac{{v}_{U E}}{c} + {R}_{U E}}$$

(corresponding to a negative direction from the time T2 216), with the relevant upper bound occurring directly at the time T2 216.

By then ensuring at the UE that its actual measurement windows (as defined by the value of min(X1, X2) and min(Y1, Y2)) as illustrated in FIG. 2 are within these bounds, the UE can be assured that the analyses of whether the time T1′ 214 properly occurs during the first measurement window 202 and whether the time T2′ 218 properly occurs during the second measurement window 204 act to check for unacceptable magnitudes of relativistic effects and clock differences (because the first measurement window 202 and the second measurement window 204 have themselves been bounded in a manner that takes into account to these relativistic effects and clock differences).

The scaling value k could be selected in the manner described previously.

In some embodiments, the DRX cycle length may (also) be used by the UE to determine an outer bound for one or both of the first measurement window 202 and the second measurement window 204, for analogous reasons and under analogous circumstances for selecting an appropriate M*DRX value as previously described. Accordingly, in such embodiments, it may be the case that values of min(X1, X2) and min(Y1, Y2) are understood to be bounded by either

$$\frac{k ⋆ {T}_{e}}{\frac{{v}_{U E}}{c} + {R}_{U E}}$$

or M*DRX, whichever is smaller. In the event that the M*DRX value is the smaller value, the lower outer bound for the first measurement window 202 may be found at T1−M*DRX (corresponding to a negative direction from the time T1 212), while an upper outer bound for the first measurement window 202 may be found at T1+M*DRX (corresponding to a positive direction from the time T1 212). Further, the lower outer bound for the second measurement window 204 may be found at T2−M*DRX (corresponding to a negative direction from the time T2 216), with the relevant upper bound occurring directly at the time T2 216.

During an RSRP measurement method (such as the RSRP measurement method 200), time interval limitations may be used as between one or more actions and/or events corresponding to the relevant times discussed herein (e.g., the actions and/or events corresponding to the time T1 212, the time T1′ 214, the time T2 216, the time T2′ 218, and/or the time T3 220, as these have been described). Herein, this concept may be expressed in terms of first of these times being within an outer bound that is determined relative to a second of these times. The descriptions of various time interval limitations that follow will illustratively discuss their aspects in relation to the RSRP measurement method 200 of FIG. 2.

Note that one or more such time interval limitations described herein may be used either with or independently from one or more of the measurement window bounding methods described previously herein.

First embodiments of time interval limitations may correspond to a time interval limitation between the time T1 212 and the time T2 216 that establishes an outer bound for the time T2 216 (in a positive direction) relative to the time T1 212. In a first case of a time interval limitation between the time T1 212 and the time T2 216, the UE may determine an outer bound adjustment amount using the maximum duration for a TA timer Timer_{MAX} (a maximum duration of a TA timer that is configured and/or reset at the time T1 212). Then, an outer bound for the time T2 216 may be set at the time T1+Timer_{MAX}. In this case, it may be understood that if the time T2 216 falls without this outer bound relative to the time T1 212, the timer (which was reset at the time T1 212) has expired prior to the time T2 216. Accordingly, the RSRP measurement method 200 being performed is determined to reflect a likelihood that the TA adjustment amount is stale, and the UE therefore may respond by cancelling the CG-SDT transmission 206. Otherwise, the UE may determine instead to proceed with the RSRP measurement method 200, as it has been described herein.

In a second case of a time interval limitation between the time T1 212 and the time T2 216, the UE may determine an outer bound adjustment amount using the maximum duration for a TA timer Timer_{MAX} and the value of

$$\frac{k ⋆ {T}_{e} ⋆ {v}_{U E}}{c}$$

(calculated as described above). The use of

$$\frac{k ⋆ {T}_{e} ⋆ {v}_{U E}}{c}$$

reflects the understanding that in this case, the expression

$$\frac{S ⋆ {v}_{U E}}{c} \leq k ⋆ {T}_{e}$$

limits the size of the time gap between the time T1 212 and the time T2 216 (represented by S) to values where it cannot be the case that more timing drift due to relativistic effects has occurred as between the UE and the base station than can be present without concern that a Tₑ constraint between the UE and the base station has been violated. Then, an outer bound for the time T2 216 may be set at the time T1 212 plus the minimum of Timerₘₐₓ and

$$\frac{k ⋆ {T}_{e} ⋆ {v}_{U E}}{c} .$$

In the case that

$$\frac{k ⋆ {T}_{e} ⋆ {v}_{U E}}{c}$$

is the minimum, and is therefore used relative to the time T1 212 to set the outer bound for the time T2 216, the UE may understand, when this outer bound relative to the time T1 212 is violated by the time T2 216, that the size of the time gap between the time T1 212 and the time T2 216 reflects a possibility that more timing drift due to relativistic effects has occurred as between the UE and the base station than can be present without concern that a Tₑ constraint between the UE and the base station has been violated. Accordingly, the RSRP measurement method 200 being performed is determined to reflect a likelihood that the TA adjustment amount is stale, and the UE may therefore respond by cancelling the CG-SDT transmission 206. Otherwise, the UE may determine instead to proceed with the RSRP measurement method 200, as it has been described herein.

In a third case of a time interval limitation between the time T1 212 and the time T2 216, the UE may determine an outer bound adjustment amount using the maximum duration for a TA timer Timer_{MAX} and the value of

$$\frac{k ⋆ {T}_{e}}{\frac{{v}_{U E}}{c} + {R}_{U E}}$$

(calculated as described above). The use of

$$\frac{k ⋆ {T}_{e}}{\frac{{v}_{U E}}{c} + {R}_{U E}}$$

reflects the understanding that in this case, the expression

$$\frac{S ⋆ {v}_{U E}}{c} + S ⋆ {R}_{U E} \leq k ⋆ {T}_{e}$$

limits the size of the time gap between the time T1 212 and the time T2 216 (represented by S) to values where it cannot be the case that more timing drift due to relativistic effects and clock differences has occurred as between the UE and the base station than can be present without concern that a Tₑ constraint between the UE and the base station has been violated. Then, an outer bound for the time T2 216 may be set at the time T1 212 plus the minimum of Timer_{MAX} and

$$\frac{k ⋆ {T}_{e}}{\frac{{v}_{U E}}{c} + {R}_{U E}} .$$

In the case that

$$\frac{k * {T}_{e}}{\frac{{v}_{U E}}{c} + {R}_{U E}}$$

is the minimum, and is therefore used relative to the time T1 212 to set the outer bound for the time T2 216, the UE may understand, when this outer bound relative to the time T1 212 is violated by the time T2 216, that the size of the time gap between the time T1 212 and the time T2 216 reflects a possibility that more timing drift due to relativistic effects and clock differences has occurred as between the UE and the base station than can be present without concern that a Tₑ constraint between the UE and the base station has been violated. Accordingly, the RSRP measurement method 200 being performed is determined to reflect a likelihood that the TA adjustment amount is stale, and the UE may therefore respond by cancelling the CG-SDT transmission 206. Otherwise, the UE may determine instead to proceed with the RSRP measurement method 200, as it has been described herein.

In a fourth case of a time interval limitation between the time T1 212 and the time T2 216, the UE may determine an outer bound adjustment amount using the maximum duration for a TA timer Timer_{MAX}, the value of

$$\frac{k * {T}_{e}}{\frac{{v}_{U E}}{c} + {R}_{U E}} ( or \frac{k * {T}_{e} ⋆ {v}_{U E}}{c} )$$

(calculated as described above), and the value M*DRX. The value M*DRX may reflect the maximum amount of time that can exist between the time T1 212 and the time T2 216 for which it can be certain that only consecutive instances of SSBs (as also understood with/in relation to their receipt on corresponding Rx beams, in the case where M>1) are measured at the time T1′ 214 and the time T2′ 218. Then, an outer bound for the time T2 216 may be set at the time T1 212 plus the minimum of Timer_{MAX}

$$\frac{k * {T}_{e}}{\frac{{v}_{U E}}{c} + {R}_{U E}} ( or \frac{k * {T}_{e} ⋆ {v}_{U E}}{c} ) ,$$

### and M*DRX.

In the case that M*DRX is the minimum, and is therefore used relative to the time T1 212 to set the outer bound for the time T2 216, the UE may understand, when this outer bound relative to the time T1 212 is violated by the time T2 216, that the size of the time gap between the time T1 212 and the time T2 216 reflects a possibility that non-consecutive instances of SSBs (as also understood with/in relation to their receipt on corresponding Rx beams, in the case where M>1) were/may be measured at the time T1′ 214 and the time T2′ 218 (where consecutive such SSB instances should have been measured). Accordingly, the RSRP measurement method 200 being performed is determined to reflect a likelihood that the TA adjustment amount is stale, and the UE may therefore respond by cancelling the CG-SDT transmission 206. Otherwise, the UE may determine instead to proceed with the RSRP measurement method 200, as it has been described herein.

Second embodiments of time interval limitations may correspond to a time interval limitation between the time T1′ 214 and the time T2′ 218 that establishes an outer bound for the time T2′ 218 relative to the time T1′ 214 (in a positive direction). In a first case of a time interval limitation between the time T1′ 214 and the time T2′ 218, the UE may determine an outer bound adjustment amount using the maximum duration for a TA timer Timer_{MAX} (a maximum duration of a TA timer that is configured and/or reset at the time T1 212). Then, an outer bound for the time T2′ 218 may be set at the time T1′+Timer_{MAX}. In this case, it may be understood that if the time T2′ 218 falls without this outer bound relative to the time T1′ 214, the timer (which was reset at the time T1 212) may have expired. Accordingly, the RSRP measurement method 200 being performed is determined to reflect a likelihood that the TA adjustment amount is stale, and the UE therefore should cancel the CG-SDT transmission 206. Otherwise, the UE may determine instead to proceed with the RSRP measurement method 200, as it has been described herein.

In a second case of a time interval limitation between the time T1′ 214 and the time T2′ 218, the UE may determine an outer bound adjustment amount using the maximum duration for a TA timer Timer_{MAX} and the value of

$$\frac{k * {T}_{e} ⋆ {v}_{U E}}{c}$$

(calculated as described above). The use of k

$$\frac{k * {T}_{e} ⋆ {v}_{U E}}{c}$$

reflects the understanding that in this case, the expression

$$\frac{S * {v}_{U E}}{c} \leq k * {T}_{e}$$

limits the size of the time gap between the time T1′ 214 and the time T2′ 218 (represented by S) to values where it cannot be the case that more timing drift due to relativistic effects has occurred as between the UE and the base station than can be present without concern that a Tₑ constraint between the UE and the base station has been violated. Accordingly, an outer bound for h time T2′ 218 may be set at the time T1′ 214 plus the minimum of Timer_{MAX} and

$$\frac{k * {T}_{e} ⋆ {v}_{U E}}{c} .$$

In the case that

$$\frac{k * {T}_{e} ⋆ {v}_{U E}}{c}$$

is the minimum, and is therefore used relative to the time T1′ 214 to set the outer bound for the time T2′ 218, the UE may understand, when this outer bound relative to the time T1′ 214 is violated by the time T2′ 218, that the size of the time gap between the time T1′ 214 and the time T2′ 218 reflects a possibility that more timing drift due to relativistic effects has occurred as between the UE and the base station than can be present without concern that a Tₑ constraint between the UE and the base station has been violated. Accordingly, the RSRP measurement method 200 being performed is determined to reflect a likelihood that the TA adjustment amount is stale, and the UE may therefore respond by cancelling the CG-SDT transmission 206. Otherwise, the UE may determine instead to proceed with the RSRP measurement method 200, as it has been described herein.

In a third case of a time interval limitation between the time T1′ 214 and the time T2′ 218, the UE may determine an outer bound adjustment amount using the maximum duration for a TA timer Timer_{MAX} and the value of

$$\frac{k * {T}_{e}}{\frac{{v}_{U E}}{c} + {R}_{U E}}$$

(calculated as described above). The use of

$$\frac{k * {T}_{e}}{\frac{{v}_{U E}}{c} + {R}_{U E}}$$

reflects the understanding that in this case, the expression

$$\frac{S * {v}_{U E}}{c} + S ⋆ {R}_{U E} \leq k * {T}_{e}$$

limits the size of the time gap between the time T1′ 214 and the time T2′ 218 (represented by S) to values where it cannot be the case that more timing drift due to relativistic effects and clock differences has occurred as between the UE and the base station than can be present without concern that a Tₑ constraint between the UE and the base station has been violated. Then, an outer bound for the time T2′ 218 may be set at the time T1′ 214 plus the minimum of Timer_{MAX} and

$$\frac{k * {T}_{e}}{\frac{{v}_{U E}}{c} + {R}_{U E}} .$$

In the case that

$$\frac{k * {T}_{e}}{\frac{{v}_{U E}}{c} + {R}_{U E}}$$

is the minimum, and is therefore used relative to the time T1′ 214 to set the outer bound for the time T2′ 218, the UE may understand, when this outer bound relative to the time T1′ 214 is violated by the time T2′ 218, that the size of the time gap between the time T1′ 214 and the time T2′ 218 reflects a possibility that more timing drift due to relativistic effects and clock differences has occurred as between the UE and the base station than can be present without concern that a Tₑ constraint between the UE and the base station has been violated. Accordingly, the RSRP measurement method 200 being performed is determined to reflect a likelihood that the TA adjustment amount is stale, and the UE may therefore respond by cancelling the CG-SDT transmission 206. Otherwise, the UE may determine instead to proceed with the RSRP measurement method 200, as it has been described herein.

In a fourth case of a time interval limitation between the time T1′ 214 and the time T2′ 218, the UE may determine an outer bound adjustment amount using the maximum duration for a TA timer Timer_{MAX}, the value of

$$\frac{k * {T}_{e}}{\frac{{v}_{U E}}{c} + {R}_{U E}} ( or \frac{k * {T}_{e} ⋆ {v}_{U E}}{c} )$$

(calculated as described above), and the value M*DRX. The value M*DRX may reflect the maximum amount of time that can exist between the time T1′ 214 and the time T2′ 218 for which it can be certain that these time represent measurements of consecutive instances of SSBs (as also understood with/in relation to their receipt on corresponding Rx beams, in the case where M>1). Then, an outer bound for the time T2′ 218 may be set at the time T1 212 plus the minimum of Timer_{MAX}

$$\frac{k * {T}_{e}}{\frac{{v}_{U E}}{c} + {R}_{U E}} ( or \frac{k * {T}_{e} ⋆ {v}_{U E}}{c} ) ,$$

### and M*DRX.

In the case that M*DRX is the minimum, and is therefore used relative to the time T1′ 214 to set the outer bound for the time T2′ 218, the UE may understand, when this outer bound relative to the time T1′ 214 is violated by the time T2′ 218, that the size of the time gap between the time T1′ 214 and the time T2′ 218 reflects a possibility that non-consecutive instances of SSBs (as also understood with/in relation to their receipt on corresponding Rx beams, in the case where M>1) were measured at the time T1′ 214 and the time T2′ 218 (where consecutive such SSB instances should have been measured). Accordingly, the RSRP measurement method 200 being performed is determined to reflect a likelihood that the TA adjustment amount is stale, and the UE may therefore respond by cancelling the CG-SDT transmission 206. Otherwise, the UE may determine instead to proceed with the RSRP measurement method 200, as it has been described herein.

Third embodiments of time interval limitations may correspond to a time interval limitation between the time T2 216 and the time T3 220 that establishes an outer bound for the time T2 216 relative to the time T3 220 (in a negative direction). In a first case of a time interval limitation between the time T2 216 and the time T3 220, the UE may determine an outer bound adjustment amount using the value of

$$\frac{k * {T}_{e} * {υ}_{U E}}{c}$$

(calculated as described above). The use of

$$\frac{k * {T}_{e} * {υ}_{U E}}{c}$$

reflects the understanding that in this case, the expression

$$\frac{S * {υ}_{U E}}{c} \leq k * {T}_{e}$$

limits the size of the time gap between the time T2 216 and the time T3 220 (represented by S) to values where it cannot be the case that more timing drift due to relativistic effects has occurred as between the UE and the base station than can be present without concern that a Tₑ constraint between the UE and the base station has been violated. Then, an outer bound for the time T2 216 may be set at the time T3 220 minus

$$\frac{k * {T}_{e} * {υ}_{U E}}{c} .$$

In this case, it may be understood that if the time T2 216 were to fall without this outer bound relative to the time T3 220, there is a possibility that more timing drift due to relativistic effects has occurred as between the UE and the base station than can be present without concern that a T_{c} constraint between the UE and the base station has been violated. Accordingly, the UE will locate the time T2 216 within this outer bound.

In a second case of a time interval limitation between the time T2 216 and the time T3 220, the UE may determine an outer bound adjustment amount using the value of

$$\frac{k * {T}_{e}}{\frac{{υ}_{U E}}{c} + {R}_{U E}}$$

(calculated as described above). The use of

$$\frac{k * {T}_{e}}{\frac{{υ}_{U E}}{c} + {R}_{U E}}$$

reflects the understanding that in this case, the expression

$$\frac{S * {υ}_{UE}}{c} + S * {R}_{U E} \leq k * {T}_{e}$$

limits the size of the time gap between the time T2 216 and the time T3 220 (represented by S) to values where it cannot be the case that more timing drift due to relativistic effects and clock differences has occurred as between the UE and the base station than can be present without concern that a Tₑ constraint between the UE and the base station has been violated. Then, an outer bound for the time T2 216 may be set at the time T3 220 minus

$$\frac{k * {T}_{e}}{\frac{{υ}_{U E}}{c} + {R}_{U E}} .$$

In this case, it may be understood that if the time T2 216 were to fall without this outer bound relative to the time T3 220, there is a possibility that more timing drift due to relativistic effects and clock differences has occurred as between the UE and the base station than can be present without concern that a Tₑ constraint between the UE and the base station has been violated. Accordingly, the UE will locate the time T2 216 within this outer bound.

In a third case of a time interval limitation between the time T2 216 and the time T3 220, the UE may determine an outer bound adjustment amount using the minimum of

$$\frac{k * {T}_{e} * {υ}_{UE}}{c} ( or \frac{k * {T}_{e}}{\frac{{υ}_{UE}}{c} + {R}_{UE}} )$$

(calculated as described above) and M*DRX (also calculated as described above). The value M*DRX may reflect the maximum amount of time that can exist between the time T2 216 and the time T3 220 for which it can be certain that no additional SSBs beyond one full set of SSBs (as also understood with/in relation to their receipt on corresponding Rx beams, in the case where M>1) have been transmitted between the time T2 216 and the time T3 220. Then, an outer bound for the time T2 216 may be set at the time T3 220 minus this minimum.

In the event that the M*DRX is the minimum and is therefore used to bound the time T2 216 relative to the time T3 220, it may be understood that if the time T2 216 were to fall without this outer bound relative to the time T3 220, there is a chance that more SSBs than are found in one full set of SSBs (as also understood with/in relation to their receipt on corresponding Rx beams, in the case where M>1) have been transmitted between the time T2 216 and the time T3 220, which would mean that the decision to use the CG-SDT transmission 206 that was taken at the time T2 216 was potentially made with (potentially) outdated SSB RSRP information. Accordingly, the UE will locate the time T2 216 within this outer bound.

In a fourth case of a time interval limitation between the time T2 216 and the time T3 220, the UE may determine an outer bound adjustment amount based on the CG-SDT periodicity 210 (and respective to any timing offset used for the CG-SDT periodicity 210). For example, an outer bound adjustment amount may be equal to the CG-SDT periodicity 210. Accordingly, an outer bound for the time T2 216 may be set at the time T3 220 minus the CG-SDT periodicity 210 (the outer bound adjustment amount).

It may be understood that if the time T2 216 were to fall without (or on) this outer bound relative to the time T3 220, there has been an intervening CG-SDT transmission occasion 208 between the time T2 216 and the CG-SDT transmission occasion 208 corresponding to the CG-SDT transmission 206, which could mean that too much time has passed between the time T2 216 and the planned CG-SDT transmission 206 to have full confidence that a Tₑ constraint between the UE and the base station has not become violated during that time. Accordingly, the UE will locate the time T2 216 within this outer bound (such that there is not an intervening CG-SDT transmission occasion 208 between the time T2 216 and the CG-SDT transmission occasion 208 used for the CG-SDT transmission 206).

Fourth embodiments of time interval limitations may correspond to a time interval limitation between the time T2′ 218 and the time T3 220 that establishes an outer bound for the time T2′ 218 relative to the time T3 220 (in a negative direction). In a first case of a time interval limitation between the time T2′ 218 and the time T3 220, the UE may determine an outer bound adjustment amount using the value of

$$\frac{k * {T}_{e} * {υ}_{U E}}{c}$$

(calculated as described above). The use of

$$\frac{k * {T}_{e} * {υ}_{U E}}{c}$$

reflects the understanding that in this case, the expression

$$\frac{S * {υ}_{U E}}{c} \leq k * {T}_{e}$$

limits the size of the time gap between the time T2′ 218 and the time T3 220 (represented by S) to values where it cannot be the case that more timing drift due to relativistic effects has occurred as between the UE and the base station than can be present without concern that a Tₑ constraint between the UE and the base station has been violated. Then, an outer bound for the time T2′ 218 may be set at the time T3 220 minus

$$\frac{k * {T}_{e} * {υ}_{U E}}{c} .$$

In this case, it may be understood that if the time T2′ 218 were to fall without this outer bound relative to the time T3 220, there is a possibility that more timing drift due to relativistic effects has occurred as between the UE and the base station than can be present without concern that a Tₑ constraint between the UE and the base station has been violated. Accordingly, the UE will locate the time T2′ 218 within this outer bound.

In a second case of a time interval limitation between the time T2′ 218 and the time T3 220, the UE may determine an outer bound adjustment amount using the value of

$$\frac{k * {T}_{e}}{\frac{{υ}_{U E}}{c} + {R}_{U E}}$$

(calculated as described above). The use of

$$\frac{k * {T}_{e}}{\frac{{υ}_{U E}}{c} + {R}_{U E}}$$

reflects the understanding that in this case, the expression

$$\frac{S * {υ}_{U E}}{c} + S * {R}_{U E} \leq k * {T}_{e}$$

limits the size of the time gap between the time T2′ 218 and the time T3 220 (represented by S) to values where it cannot be the case that more timing drift due to relativistic effects and clock differences has occurred as between the UE and the base station than can be present without concern that a Tₑ constraint between the UE and the base station has been violated. Then, an outer bound for the time T2′ 218 may be set at the time T3 220 minus

$$\frac{k * {T}_{e}}{\frac{{υ}_{U E}}{c} + {R}_{U E}} .$$

In this case, it may be understood that if the time T2′ 218 were to fall without this outer bound relative to the time T3 220, there is a possibility that more timing drift due to relativistic effects and clock differences has occurred as between the UE and the base station than can be present without concern that a Tₑ constraint between the UE and the base station has been violated. Accordingly, the UE will locate the time T2′ 218 within this outer bound.

In a third case of a time interval limitation between the time T2′ 218 and the time T3 220, the UE may determine an outer bound adjustment amount using the minimum of

$$\frac{k * {T}_{e} * {υ}_{U E}}{c} ( or \frac{k * {T}_{e}}{\frac{{υ}_{UE}}{c} + {R}_{U E}} )$$

(calculated as described above) and M*DRX (also calculated as described above). The value M*DRX may reflect the maximum amount of time that can exist between the time T2 216 and the time T3 220 for which it can be certain that no additional SSBs beyond one full set of SSBs (as also understood with/in relation to their receipt on corresponding Rx beams, in the case where M>1) have been transmitted between the time T2′ 218 and the time T3 220. Then, an outer bound for the time T2′ 218 may be set at the time T3 220 minus this minimum.

In the event that the M*DRX is the minimum and is therefore used to bound the time T2′ 218 relative to the time T3 220, it may be understood that if the time T2′ 218 were to fall without this outer bound relative to the time T3 220, there is a chance that more SSBs than are found in one full set of SSBs (as also understood with/in relation to their receipt on corresponding Rx beams, in the case where M>1) has occurred between the time T2′ 218 and the time T3 220, which would mean that the decision to use the CG-SDT transmission 206 that was taken at the time T2 216 was potentially made with (potentially) outdated SSB RSRP information. Accordingly, the UE will locate the time T2′ 218 within this outer bound.

In a fourth case of a time interval limitation between the time T2′ 218 and the time T3 220, the UE may determine an outer bound adjustment amount based on the CG-SDT periodicity 210 (and respective to any timing offset used for the CG-SDT periodicity 210). For example, an outer bound adjustment amount may be equal to the CG-SDT periodicity 210. Accordingly, an outer bound for the time T2′ 218 may be set at the time T3 220 minus the CG-SDT periodicity 210 (the outer bound adjustment amount).

It may be understood that if the time T2′ 218 were to fall without (or on) this outer bound relative to the time T3 220, there has been an intervening CG-SDT transmission occasion 208 between the time T2′ 218 and the CG-SDT transmission occasion 208 corresponding to the CG-SDT transmission 206, which could mean that too much time has passed between the time T2′ 218 and the planned CG-SDT transmission 206 to have full confidence that a Tₑ constraint between the UE and the base station has not become violated during that time. Accordingly, the UE will locate the time T2′ 218 within this outer bound (such that here is not an intervening CG-SDT transmission occasion 208 between the time T2′ 218 and the CG-SDT transmission occasion 208 used for the CG-SDT transmission 206).

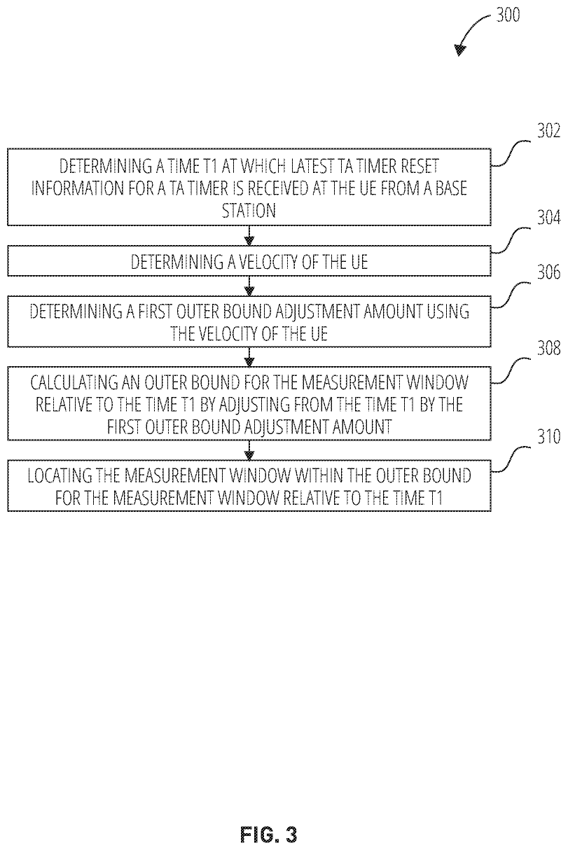

FIG. 3 illustrates a method 300 for bounding a measurement window of a TA validation for a CG-SDT, in accordance with one embodiment. The method 300 includes determining 302 a time T1 at which latest TA timer reset information for a TA timer is received at the UE from a base station.

The method 300 further includes determining 304 a velocity of the UE.

The method 300 further includes determining 306 a first outer bound adjustment amount using the velocity of the UE.

The method 300 further includes calculating 308 an outer bound for the measurement window relative to the time T1 by adjusting from the time T1 by the first outer bound adjustment amount.

The method 300 further includes locating 310 the measurement window within the outer bound for the measurement window relative to the time T1.

In some embodiments of the method 300, the first outer bound adjustment amount is determined using a formula

$$\frac{k * {T}_{e} * {υ}_{U E}}{c} ,$$

where: k is a scaling factor; T_{c} is a timing error tolerance for the UE; c is the speed of light; and v_{UE} is the velocity of the UE.

In some embodiments of the method 300, the first outer bound adjustment amount is further determined using a DRX cycle duration used by the UE.

In some embodiments of the method 300, the first outer bound adjustment amount is further determined using a clock drift rate of the UE relative to the base station. In some of these embodiments, the first outer bound adjustment amount is determined using a formula

$$\frac{k * {T}_{e}}{\frac{{υ}_{U E}}{c} + {R}_{U E}} ,$$

where: k is a scaling factor; Tₑ is a timing error tolerance for the UE; c is the speed of light; v_{UE} is the velocity of the UE; and R_{UE} is the clock drift rate of the UE relative to the base station. In some of these embodiments, the first outer bound adjustment amount is further determined using a DRX cycle duration used by the UE.

In some embodiments of the method 300, the measurement window is to be used by the UE for RSRP measurement of one or more SSBs as part of the TA validation.

In some embodiments of the method 300, the measurement window is a first-in-time measurement window of a pair of measurement windows used during the TA validation.

In some embodiments of the method 300, the outer bound for the measurement window relative to the time T1 is calculated by adjusting from the time T1 by the first outer bound adjustment amount in a negative direction.

In some embodiments of the method 300, the outer bound for the measurement window relative to the time T1 is calculated by adjusting from the time T1 by the first outer bound adjustment amount in a positive direction.

In some embodiments, the method 300 further comprises determining a maximum duration for the TA timer; determining a second outer bound adjustment amount using the maximum duration for the TA timer; calculating an outer bound for a time T2 at which the UE determines whether to perform the CG-SDT relative to the time T1 by adjusting from the time T1 by the second outer bound adjustment amount; and determining whether to proceed with the TA validation based on whether the time T2 is within the outer bound for the time T2 relative to the time T1.

In some embodiments, the method 300 further comprises determining a time T3 at which the UE is configured to perform the CG-SDT; calculating an outer bound for a time T2 at which the UE determines whether to perform the CG-SDT relative to the time T3 by adjusting from the time T3 by the first outer bound adjustment amount in a negative direction; and locating the time T2 within the outer bound for the time T2 relative to the time T3.

In some embodiments, the method 300 further comprises determining a time T3 at which the UE is configured to perform the CG-SDT, wherein the time T3 corresponds to a periodic CG-SDT occasion; and locating a time T2 at which the UE determines whether to perform the CG-SDT such that there is no intervening periodic CG-SDT occasion between the time T2 and the periodic CG-SDT occasion corresponding to the time T3.

Embodiments contemplated herein include an apparatus comprising means to perform one or more elements of the method 300. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 300. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 300. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 300. This apparatus may be, for example, an apparatus of a UE (such as a wireless device 902 that is a UE, as described herein).

Embodiments contemplated herein include a signal as described in or related to one or more elements of the method 300.

Embodiments contemplated herein include a computer program or computer program product comprising instructions, wherein execution of the program by a processor is to cause the processor to carry out one or more elements of the method 300. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

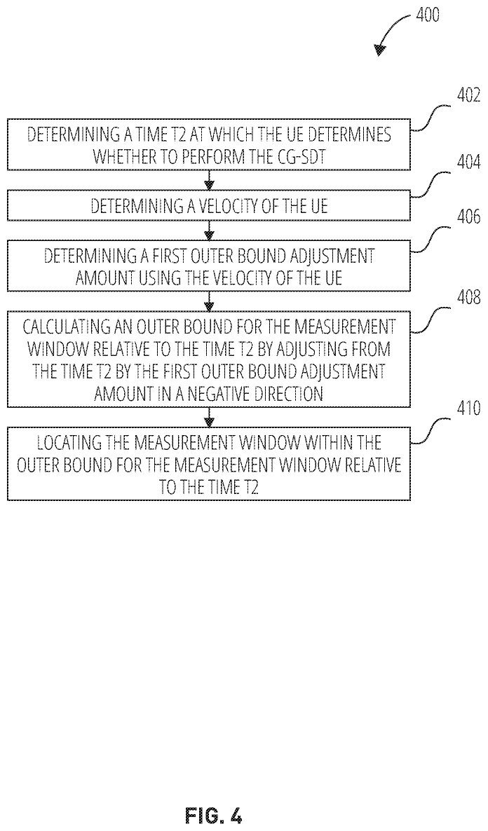

FIG. 4 illustrates a method 400 for bounding a measurement window of a TA validation for a CG-SDT, in accordance with one embodiment. The method 400 includes determining 402 a time T2 at which the UE determines whether to perform the CG-SDT.

The method 400 further includes determining 404 a velocity of the UE.

The method 400 further includes determining 406 a first outer bound adjustment amount using the velocity of the UE.

The method 400 further includes calculating 408 an outer bound for the measurement window relative to the time T2 by adjusting from the time T2 by the first outer bound adjustment amount in a negative direction.

The method 400 further includes locating 410 the measurement window within the outer bound for the measurement window relative to the time T2.

In some embodiments of the method 400, the first outer bound adjustment amount is determined using a formula

$$\frac{k * {T}_{e} * {υ}_{U E}}{c} ,$$

where: k is a scaling factor; T_{c} is a timing error tolerance for the UE; c is the speed of light; and v_{UE} is the velocity of the UE.

In some embodiments of the method 400, the first outer bound adjustment amount is further determined using a DRX cycle duration used by the UE.

In some embodiments of the method 400, the first outer bound adjustment amount is further determined using a clock drift rate of the UE relative to a base station to which the UE is configured to send the CG-SDT. In some of these embodiments, the first outer bound adjustment amount is determined using a formula

$$\frac{k * {T}_{e}}{\frac{{υ}_{U E}}{c} + {R}_{U E}} ,$$

where: k is a scaling factor; Tₑ is a timing error tolerance for the UE; c is the speed of light; v_{UE} is the velocity of the UE; and R_{UE} is the clock drift rate of the UE relative to the base station to which the UE is configured to send the CG-SDT. In some of these embodiments, the first outer bound adjustment amount is further determined using a DRX cycle duration used by the UE.

In some embodiments of the method 400, the measurement window is to be used by the UE for RSRP measurement of one or more SSBs as part of the TA validation.

In some embodiments of the method 400, the measurement window is a second-in-time measurement window of a pair of measurement windows used during the TA validation.

In some embodiments, the method 400 further comprises determining a time T1 at which latest TA timer reset information for a TA timer is received at the UE from a base station: determining a maximum duration for the TA timer; determining a second outer bound adjustment amount using the maximum duration for the TA timer; calculating an outer bound for the time T2 relative to the time T1 by adjusting from the time T1 by the second outer bound adjustment amount; and determining whether to proceed with the TA validation based on whether the time T2 is within the outer bound for the time T2 relative to the time T1.

In some embodiments, the method 400 further comprises determining a time T3 at which the UE is configured to perform the CG-SDT; calculating an outer bound for the time T2 relative to the time T3 by adjusting from the time T3 by the first outer bound adjustment amount in the negative direction; and locating the time T2 within the outer bound for the time T2 relative to the time T3.

In some embodiments, the method 400 further comprises determining a time T3 at which the UE is configured to perform the CG-SDT, wherein the time T3 corresponds to a periodic CG-SDT occasion; and locating the time T2 such that there is no intervening periodic CG-SDT occasion between the time T2 and the periodic CG-SDT occasion corresponding to the time T3.

Embodiments contemplated herein include an apparatus comprising means to perform one or more elements of the method 400. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 400. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 400. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 400. This apparatus may be, for example, an apparatus of a UE (such as a wireless device 902 that is a UE, as described herein).

Embodiments contemplated herein include a signal as described in or related to one or more elements of the method 400.

Embodiments contemplated herein include a computer program or computer program product comprising instructions, wherein execution of the program by a processor is to cause the processor to carry out one or more elements of the method 400. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

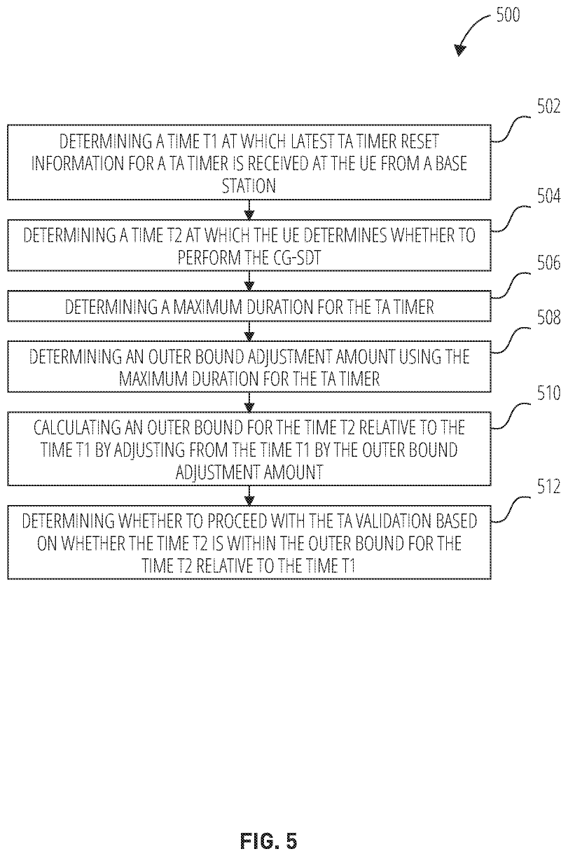

FIG. 5 illustrates a method 500 for TA validation for a CG-SDT, in accordance with one embodiment. The method 500 includes determining 502 a time T1 at which latest TA timer reset information for a TA timer is received at the UE from a base station.

The method 500 further includes determining 504 a time T2 at which the UE determines whether to perform the CG-SDT.

The method 500 includes determining 506 a maximum duration for the TA timer.

The method 500 further includes determining 508 an outer bound adjustment amount using the maximum duration for the TA timer.

The method 500 further includes calculating 510 an outer bound for the time T2 relative to the time T1 by adjusting from the time T1 by the outer bound adjustment amount.

The method 500 further includes determining 512 whether to proceed with the TA validation based on whether the time T2 is within the outer bound for the time T2 relative to the time T1.

In some embodiments, the method 500 further comprises determining a velocity of the UE, wherein the outer bound adjustment amount is further determined using the velocity of the UE. In some of these cases, the outer bound adjustment amount is determined using a formula

$$\frac{k * {T}_{e} * {υ}_{U E}}{c} ,$$

where: k is a scaling factor; Tₑ is a timing error tolerance for the UE; c is the speed of light; and v_{UE} is the velocity of the UE.

In some of these cases, the outer bound adjustment amount is further determined using a clock drift rate of the UE relative to the base station. In some of such instances, the outer bound adjustment amount is determined using a formula

$$\frac{k * {T}_{e}}{\frac{{υ}_{U E}}{c} + {R}_{U E}} ,$$

where: k is a scaling factor; Tₑ is a timing error tolerance for the UE; c is the speed of light; v_{UE} is the velocity of the UE; and R_{UE} is the clock drift rate of the UE relative to the base station. In some such instances, the first outer bound adjustment amount is further determined using a DRX cycle duration used by the UE. In some of these instances, the outer bound adjustment amount is further determined using a DRX cycle duration used by the UE.

Embodiments contemplated herein include an apparatus comprising means to perform one or more elements of the method 500. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 500. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 500. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 500. This apparatus may be, for example, an apparatus of a UE (such as a wireless device 902 that is a UE, as described herein).

Embodiments contemplated herein include a signal as described in or related to one or more elements of the method 500.

Embodiments contemplated herein include a computer program or computer program product comprising instructions, wherein execution of the program by a processor is to cause the processor to carry out one or more elements of the method 500. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

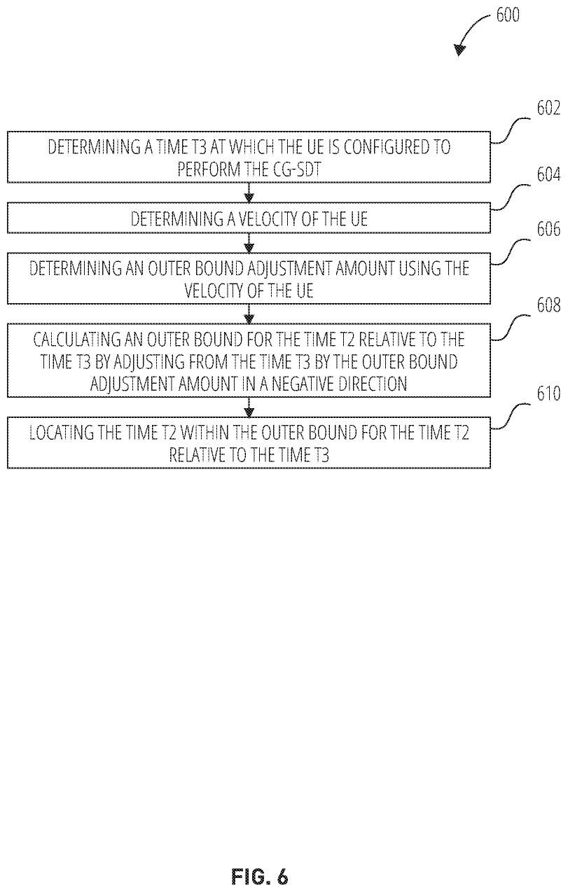

FIG. 6 illustrates a method 600 for bounding a time T2 at which the UE determines whether to perform a CG-SDT within a TA validation, in accordance with one embodiment.

The method 600 includes determining 602 a time T3 at which the UE is configured to perform the CG-SDT.

The method 600 further includes determining 604 a velocity of the UE.

The method 600 further includes determining 606 an outer bound adjustment amount using the velocity of the UE.

The method 600 further includes calculating 608 an outer bound for the time T2 relative to the time T3 by adjusting from the time T3 by the outer bound adjustment amount in a negative direction.

The method 600 further includes locating 610 the time T2 within the outer bound for the time T2 relative to the time T3.

In some embodiments of the method 600, the outer bound adjustment amount is determined using a formula

$$\frac{k * {T}_{e} * {υ}_{U E}}{c} ,$$

where: k is a scaling factor; Tₑ is a timing error tolerance for the UE; c is the speed of light; and v_{UE} is the velocity of the UE.

In some embodiments of the method 600, the outer bound adjustment amount is further determined using a clock drift rate of the UE relative to a base station to which the UE is configured to send the CG-SDT. In some of these cases, the outer bound adjustment amount is determined using a formula

$$\frac{k * {T}_{e}}{\frac{{υ}_{U E}}{c} + {R}_{U E}} ,$$

where: k is a scaling factor; T_{c} is a timing error tolerance for the UE; c is the speed of light; v_{UE} is the velocity of the UE; and R_{UE} is the clock drift rate of the UE relative to the base station to which the UE is configured to send the CG-SDT. In some of these cases, the outer bound adjustment amount is further determined using a discontinuous reception (DRX) cycle duration used by the UE.

In some embodiments of the method 600, the time T3 corresponds to a periodic CG-SDT occasion to be potentially used to perform the CG-SDT.

Embodiments contemplated herein include an apparatus comprising means to perform one or more elements of the method 600. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 600. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a UE (such as a wireless device 902 that is a UE, as described herein).

Embodiments contemplated herein include a signal as described in or related to one or more elements of the method 600.

Embodiments contemplated herein include a computer program or computer program product comprising instructions, wherein execution of the program by a processor is to cause the processor to carry out one or more elements of the method 600. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

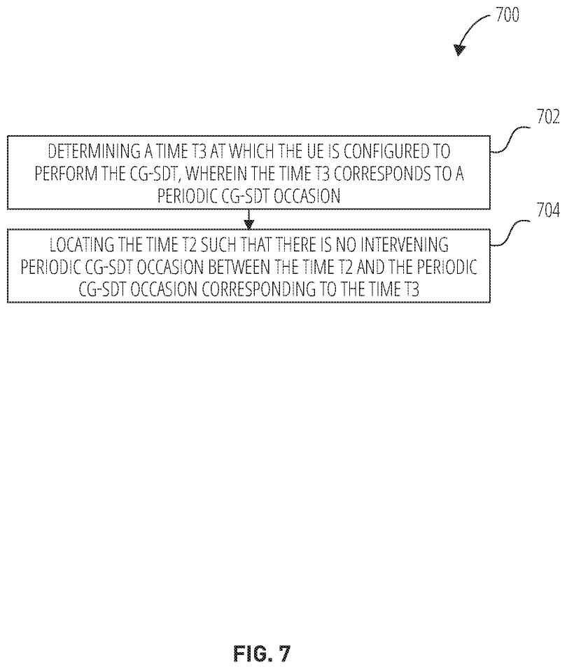

FIG. 7 illustrates a method 700 for bounding a time T2 at which the UE determines whether to perform a CG-SDT within a TA validation, in accordance with one embodiment. The method 700 includes determining 702 a time T3 at which the UE is configured to perform the CG-SDT, wherein the time T3 corresponds to a periodic CG-SDT occasion.

The method 700 further includes locating 704 the time T2 such that there is no intervening periodic CG-SDT occasion between the time T2 and the periodic CG-SDT occasion corresponding to the time T3.

Embodiments contemplated herein include an apparatus comprising means to perform one or more elements of the method 700. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 700. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a UE (such as a wireless device 902 that is a UE, as described herein).

Embodiments contemplated herein include a signal as described in or related to one or more elements of the method 700.

Embodiments contemplated herein include a computer program or computer program product comprising instructions, wherein execution of the program by a processor is to cause the processor to carry out one or more elements of the method 700. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

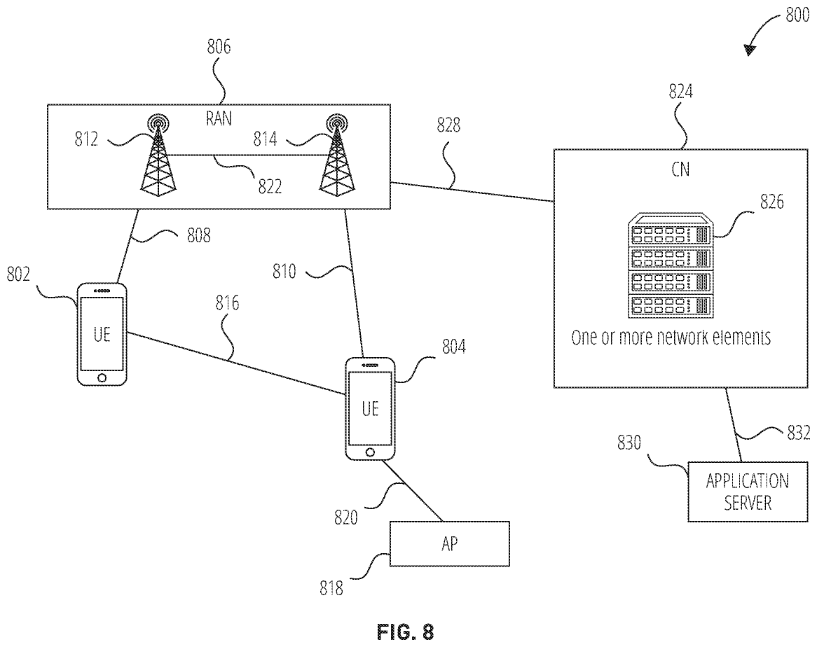

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations, such as base station 812 and base station 814, that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

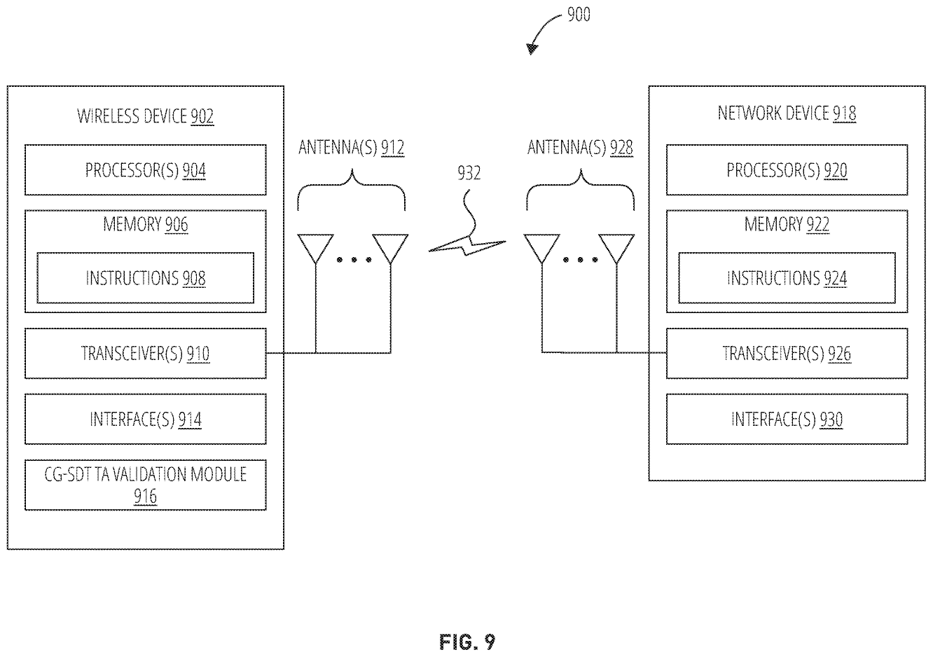

FIG. 9 illustrates a system 900 for performing signaling 932 between a wireless device 902 and a network device 918, according to embodiments disclosed herein. The system 900 may be a portion of a wireless communications system as herein described. The wireless device 902 may be, for example, a UE of a wireless communication system. The network device 918 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter and/or receiver circuitry that use the antenna(s) 912 of the wireless device 902 to facilitate signaling (e.g., the signaling 932) to and/or from the wireless device 902 with other devices (e.g., the network device 918) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include a CG-SDT TA validation module 916. The CG-SDT TA validation module 916 may be implemented via hardware, software, or combinations thereof. For example, the CG-SDT TA validation module 916 may be implemented as a processor, circuit, and/or instructions 908 stored in the memory 906 and executed by the processor(s) 904. In some examples, the CG-SDT TA validation module 916 may be integrated within the processor(s) 904 and/or the transceiver(s) 910. For example, the CG-SDT TA validation module 916 may be implemented by a combination of software components (e.g., executed by a DSP or a general processor) and hardware components (e.g., logic gates and circuitry) within the processor(s) 904 or the transceiver(s) 910.

The CG-SDT TA validation module 916 may be used for various aspects of the present disclosure, for example, aspects of FIG. 1 and FIG. 2. For example, the CG-SDT TA validation module 916 may be configured to implement, at the wireless device 902, an SDT-TATimer based method and/or an RSRP measurement method, as these have been described herein.

The network device 918 may include one or more processor(s) 920. The processor(s) 920 may execute instructions such that various operations of the network device 918 are performed, as described herein. The processor(s) 920 may include one or more baseband processors implemented using, for example, a CPU, a DSP, an ASIC, a controller, an FPGA device, another hardware device, a firmware device, or any combination thereof configured to perform the operations described herein.

The network device 918 may include a memory 922. The memory 922 may be a non-transitory computer-readable storage medium that stores instructions 924 (which may include, for example, the instructions being executed by the processor(s) 920). The instructions 924 may also be referred to as program code or a computer program. The memory 922 may also store data used by, and results computed by, the processor(s) 920.

The network device 918 may include one or more transceiver(s) 926 that may include RF transmitter and/or receiver circuitry that use the antenna(s) 928 of the network device 918 to facilitate signaling (e.g., the signaling 932) to and/or from the network device 918 with other devices (e.g., the wireless device 902) according to corresponding RATs.

The network device 918 may include one or more antenna(s) 928 (e.g., one, two, four, or more). In embodiments having multiple antenna(s) 928, the network device 918 may perform MIMO, digital beamforming, analog beamforming, beam steering, etc., as has been described.

The network device 918 may include one or more interface(s) 930. The interface(s) 930 may be used to provide input to or output from the network device 918. For example, a network device 918 that is a base station may include interface(s) 930 made up of transmitters, receivers, and other circuitry (e.g., other than the transceiver(s) 926/antenna(s) 928 already described) that enables the base station to communicate with other equipment in a core network, and/or that enables the base station to communicate with external networks, computers, databases, and the like for purposes of operations, administration, and maintenance of the base station or other equipment operably connected thereto.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE) for bounding a measurement window of a timing advance (TA) validation for a configured grant small data transmission (CG-SDT), comprising:
determining a time T1 at which latest TA timer reset information for a TA timer is received at the UE from a base station;
determining a velocity of the UE;
determining a first outer bound adjustment amount using the velocity of the UE;
calculating an outer bound for the measurement window relative to the time T1 by adjusting from the time T1 by the first outer bound adjustment amount; and
locating the measurement window within the outer bound for the measurement window relative to the time T1.

2. The method of claim 1, wherein the first outer bound adjustment amount is determined using a formula:
$$\frac{k * {T}_{e} * c}{{υ}_{U E}} ,$$
where:
k is a scaling factor;
Tₑ is a timing error tolerance for the UE;
c is the speed of light; and
v_{UE} is the velocity of the UE.

3. The method of claim 1, wherein the first outer bound adjustment amount is further determined using a discontinuous reception (DRX) cycle duration used by the UE.

4. The method of claim 1, wherein the first outer bound adjustment amount is further determined using a clock drift rate of the UE relative to the base station.

5. The method of claim 4, wherein the first outer bound adjustment amount is determined using a formula:
$$\frac{k * {T}_{e} * c}{\frac{{υ}_{U E}}{c} + {R}_{U E}} ,$$
where:
k is a scaling factor;
Tₑ is a timing error tolerance for the UE;
c is the speed of light;
v_{UE} is the velocity of the UE; and
R_{UE} is the clock drift rate of the UE relative to the base station.

6. The method of claim 4, wherein the first outer bound adjustment amount is further determined using a discontinuous reception (DRX) cycle duration used by the UE.

7. The method of claim 1, wherein the measurement window is to be used by the UE for reference signal received power (RSRP) measurement of one or more synchronization signal blocks (SSBs) as part of the TA validation.

8. The method of claim 1, wherein the measurement window is a first-in-time measurement window of a pair of measurement windows used during the TA validation.

9. The method of claim 1, wherein the outer bound for the measurement window relative to the time T1 is calculated by adjusting from the time T1 by the first outer bound adjustment amount in a negative direction.

10. The method of claim 1, wherein the outer bound for the measurement window relative to the time T1 is calculated by adjusting from the time T1 by the first outer bound adjustment amount in a positive direction.

11. The method of claim 1, further comprising:
determining a maximum duration for the TA timer;
determining a second outer bound adjustment amount using the maximum duration for the TA timer;
calculating an outer bound for a time T2 at which the UE determines whether to perform the CG-SDT relative to the time T1 by adjusting from the time T1 by the second outer bound adjustment amount; and
determining whether to proceed with the TA validation based on whether the time T2 is within the outer bound for the time T2 relative to the time T1.

12. The method of claim 1, further comprising:
determining a time T3 at which the UE is configured to perform the CG-SDT;
calculating an outer bound for a time T2 at which the UE determines whether to perform the CG-SDT relative to the time T3 by adjusting from the time T3 by the first outer bound adjustment amount in a negative direction; and
locating the time T2 within the outer bound for the time T2 relative to the time T3.

13. The method of claim 1, further comprising:
determining a time T3 at which the UE is configured to perform the CG-SDT, wherein the time T3 corresponds to a periodic CG-SDT occasion; and
locating a time T2 at which the UE determines whether to perform the CG-SDT such that there is no intervening periodic CG-SDT occasion between the time T2 and the periodic CG-SDT occasion corresponding to the time T3.

14. A method of a user equipment (UE) for bounding a measurement window of a timing advance (TA) validation for a configured grant small data transmission (CG-SDT), comprising:
determining a time T2 at which the UE determines whether to perform the CG-SDT;
determining a velocity of the UE;
determining a first outer bound adjustment amount using the velocity of the UE;
calculating an outer bound for the measurement window relative to the time T2 by adjusting from the time T2 by the first outer bound adjustment amount in a negative direction; and
locating the measurement window within the outer bound for the measurement window relative to the time T2.

15. The method of claim 14, wherein the first outer bound adjustment amount is determined using a formula:
$$\frac{k * {T}_{e} * c}{{υ}_{U E}} ,$$
where:
k is a scaling factor;
Tₑ is a timing error tolerance for the UE;
c is the speed of light; and
v_{UE} is the velocity of the UE.

16. The method of claim 14, wherein the first outer bound adjustment amount is further determined using a discontinuous reception (DRX) cycle duration used by the UE.

17. The method of claim 14, wherein the first outer bound adjustment amount is further determined using a clock drift rate of the UE relative to a base station to which the UE is configured to send the CG-SDT.

18. The method of claim 17, wherein the first outer bound adjustment amount is determined using a formula:
$$\frac{k * {T}_{e} * c}{\frac{{υ}_{U E}}{c} + {R}_{U E}} ,$$
where:
k is a scaling factor;
Tₑ is a timing error tolerance for the UE;
c is the speed of light;
vᵤₑ is the velocity of the UE; and
R_{UE} is the clock drift rate of the UE relative to the base station to which the UE is configured to send the CG-SDT.

19. The method of claim 17, wherein the first outer bound adjustment amount is further determined using a discontinuous reception (DRX) cycle duration used by the UE.

20. The method of claim 14, wherein the measurement window is to be used by the UE for reference signal received power (RSRP) measurement of one or more synchronization signal blocks (SSBs) as part of the TA validation.

21-42. (canceled)
